(19) United States
(12) Patent Application Publication
(10) Pub. No.: US 2025/0219135 A1
(43) Pub. Date: Jul. 3, 2025

(54) SULFIDE SOLID ELECTROLYTE MATERIAL AND COMPOSITE

(71) Applicant: Solid Power Operating, Inc., Louisville, CO (US)

(72) Inventors: Sean P. CULVER, Broomfield, CO (US); Bradley J. ROSS, Norman, OK (US); Victoria R. BACHTELL, Broomfield, CO (US)

(21) Appl. No.: 19/005,590

(22) Filed: Dec. 30, 2024

Related U.S. Application Data
(60) Provisional application No. 63/616,238, filed on Dec. 29, 2023.

(51) Int. Cl. H01M 10/0562; H01M 10/0525

(52) U.S. Cl. CPC H01M 10/0562; H01M 10/0525; H01M 2300/008

(57) ABSTRACT

The present disclosure provides an electrolyte composition. The present disclosure also provides a composite composition comprising the electrolyte composition and an Argyrodite phase. Furthermore, the present disclosure is directed to a method of making and using the electrolyte composition.

### CROSS-REFERENCE TO RELATED APPLICATION

This application is related to and claims priority under 35 U.S.C. § 119(e) from U.S. Patent Application No. 63/616,238, filed Dec. 29, 2023, titled “Sulfide Solid Electrolyte Material and Composite Containing Thereof,” the entire contents of which is incorporated herein by reference for all purposes.

### TECHNICAL FIELD

This disclosure generally relates to a sulfide solid electrolyte composition and method of making the composition.

### BACKGROUND AND INTRODUCTION

The proliferation of battery powered devices including mobile computing devices and smart phones, and hybrid/electric automobiles among others, is motivating innovations in all aspects of battery technologies. Solid-state battery technologies represent opportunities to improve on a host of areas that are important for commercial application of batteries including reliability, capacity (mAh), thermal characteristics, safety, cycle life, and recharge performance, among others.

Conventional liquid electrolyte lithium-ion batteries often have a liquid electrolyte containing a flammable organic solvent and therefore, attachment of a safety device that suppresses an increase in temperature at the time of a short circuit or other event, or improvement in structural and material aspects for preventing such short circuits is often required. On the other hand, a solid-state battery using a solid electrolyte in place of the liquid electrolyte, such flammable organic solvents may not be used, and therefore, while there may still be a risk from short circuits, the risk is less and the safety device may be simplified.

It is with these observations in mind, among others, that aspects of the present disclosure were conceived. In short summary, the present disclosure provides novel compositions and a method to produce sulfide solid electrolytes.

### SUMMARY

A sulfide solid electrolyte is known as a solid electrolyte used in a lithium-ion battery. Various crystal structures of sulfide solid electrolytes are known, and a stable crystal structure whose structure is hardly changed over a wide temperature range is suitable in terms of expanding the operating temperature range of the battery. Among them, as disclosed herein, a sulfide solid electrolyte having an argyrodite-type crystal structure has a stable crystal structure.

The present disclosure is directed to a method of producing, separating, and purifying metal sulfides. The present disclosure further relates to a solid electrolyte, including electrolytes having an argyrodite-type crystal structure.

The present disclosure generally relates to a composition comprising Li₃P₂S₆X, wherein X is a halogen. The halogen may be chlorine, bromine, or a combination thereof.

In some embodiments, the composition comprises an XRD peak at 2θ=29.3°±0.5°. In some embodiments, the composition comprises an XRD peak at 2θ=33.9°±0.5°. In some embodiments, the composition comprises an XRD peak at 2θ=14.6°±0.5°. In some embodiments, the composition comprises an XRD peak at 2θ=49°±0.5°. In some embodiments, the composition comprises an XRD peak at 2θ=57°±0.5°.

In some embodiments, the composition comprises an XRD peak at 2θ at three or more of 14.6°±0.5°, 29.3°±0.5°, 33.9°±0.5°, 49°±0.5°, and 57°±0.5°. In some embodiments, an XRD peak 2θ at four or more of 14.6°±0.5°, 29.3°±0.5°, 33.9°±0.5°, 49°±0.5°, and 57°±0.5°.

In some embodiments, the composition comprises an XRD peak at 2θ=14.6°±0.5°, 29.3°±0.5°, 33.9°±0.5°, 49°±0.5°, and 57°±0.5°. In some embodiments, the composition an XRD peak at 2θ=14.6°±0.3°, 29.3°±0.3°, 33.9°±0.3°, 49°±0.3°, and 57°±0.3°. In some embodiments, the composition comprises an XRD peak at 2θ=14.6°±0.1°, 29.3°±0.1°, 33.9°±0.1°, 49°±0.1°, and 57°±0.1°.

The present disclosure further relates to a composite composition comprising an Argyrodite phase and a Li₃P₂S₆X phase, wherein X is a halogen. The halogen may be chlorine, bromine, or a combination thereof.

In some embodiments, the composite comprises an XRD peak at 2θ=29°±0.5°. In some embodiments, the composite comprises an XRD peak at 2θ=34°±0.5°. In some embodiments, the composite comprises an XRD peak at 2θ=14.9°±0.5°. In some embodiments, the composite comprises an XRD peak at 2θ=30.5°±0.5°.

In some embodiments, the composition comprises an XRD peak at 2θ at three or more of 14.9°±0.5°, 29°±0.5°, 30.5°±0.5°, and 34°±0.5°. In some embodiments, the composition comprises an XRD peak at 2θ=14.9°±0.5°, 29°±0.5°, 30.5°±0.5°, and 34°±0.5°. In some embodiments, the composition comprises an XRD peak at 2θ=14.9°±0.3°, 29°±0.3°, 30.5°±0.3°, and 34°±0.3°. In some embodiments, the composition comprises an XRD peak at 2θ=14.9°±0.1°, 29°±0.1°, 30.5°±0.1°, and 34°±0.1°.

In some embodiments, the composite composition comprises about 10 wt % or less of the Li₃P₂S₆X phase. In some embodiments, the composite composition comprises about 5 wt % or less of the Li₃P₂S₆X phase. In some embodiments, the composite composition comprises about 3 wt % or less of the Li₃P₂S₆X phase. In some embodiments, the composite composition comprises about 1 wt % or less of the Li₃P₂S₆X phase.

In some embodiments, the ratio of peak area of peak at 30.5° to ratio of peak area of peak at 29° is from about 100:1 to about 10:1. In some embodiments, the ratio of peak area of peak at 30.5° to ratio of peak area of peak at 34° is from about 100:1 to about 10:1. In some embodiments, the ratio of peak area of peak at 14.9° to ratio of peak area of peak at 34° is from about 100:1 to about 10:1.

Aspects of the present disclosure also relate to a composition comprising Li_{3±0.75}P_{2±0.75}S_{6±0.75}X_{1±0.75}. X may be a halogen. The composition may have an XRD peak at 2θ at three or more of 14.6°±0.5°, 29.3°±0.5°, 33.9°±0.5°, 49°±0.5°, and 57°±0.5°.

Aspects of the present disclosure also relate to a method of making Li₃P₂S₆X, the method comprising mixing Li₂S, P₂S₅, and LiX, wherein X is a halogen.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure may be understood by reference to the following detailed description taken in conjunction with the drawings briefly described below. It is noted that, for purposes of illustrative clarity, certain elements in the drawings may not be drawn to scale.

FIG. 1A shows XRD patterns of electrolyte compositions obtained according to the present disclosure.

FIG. 1B shows Thermogravimetric Analysis (TGA) graphs of electrolyte compositions obtained according to the present disclosure.

FIG. 2 shows XRD patterns of electrolyte compositions obtained according to the present disclosure.

FIG. 3 shows XRD patterns of electrolyte compositions obtained according to the present disclosure.

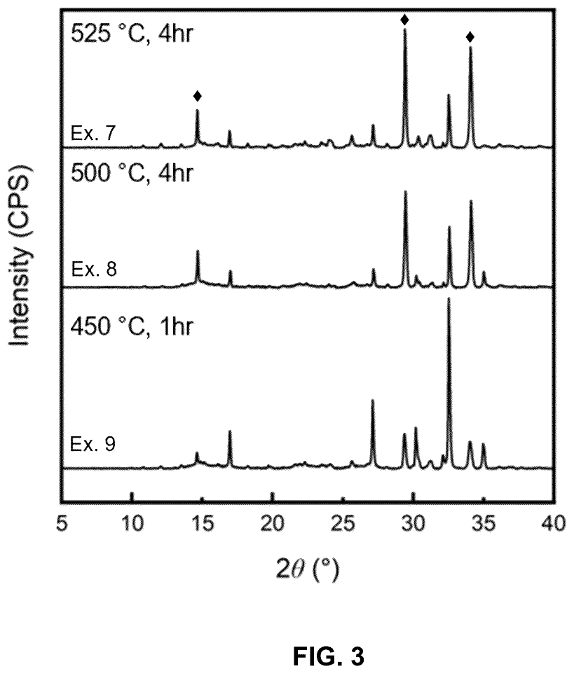

FIG. 4 shows a Raman spectrum of the electrolyte composition obtained according

to the present disclosure.

FIG. 5 shows a XRD pattern of a composite composition obtained according to the present disclosure.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising and are open ended terms.

The indefinite articles “a” and “an,” as used herein in the specification and in the claims, unless clearly indicated to the contrary, should be understood to mean “at least one.”

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e. single component material, with respect to both chemical and crystalline composition, or it may contain a mixture of components having different chemical compositions and/or crystalline structures.

As used herein, the term “composite” refers to a mixture of at least two components having distinct chemical compositions and/or crystalline structures.

As used herein, the term “compound” refers to a component defined by a single chemical composition and a single crystalline structure.

The current disclosure provides a composition of a sulfide electrolyte material. The sulfide electrolyte material comprises Li₃P₂S₆X, wherein X is a halogen. The halogen includes but is not limited to fluorine, chlorine, bromine, or iodine. In some embodiments, the electrolyte composition may be Li_{3±0.75}P_{2±0.75}S_{6±0.75}X_{1±0.75}, wherein X is a halogen, and wherein the composition comprises an XRD peak at 2θ at three or more of 14.6°±0.5°, 29.3°±0.5°, 33.9°±0.5°, 49°±0.5°, and 57°±0.5°. In one embodiment, the electrolyte may be Li₃P₂S₆Cl.

The sulfide electrolyte material of the present disclosure may have an X-Ray Diffraction (XRD) pattern having one or more peaks expressed in degrees 2θ at 14.6°±0.5°, 29.3°±0.5°, 33.9°±0.5°, 49°±0.5°, and 57°±0.5°. In some aspects, the compositions of the present disclosure may have an XRD pattern having two or more, three or more, four or more, or five or more peaks expressed in degrees 2θ at 14.6°±0.5°, 29.3°±0.5°, 33.9°±0.5°, 49°±0.5°, and 57°±0.5°. Further, the composition may have one or more peaks at 14.6°±0.5°, 29.3°±0.5°, 33.9°±0.5°, 49°±0.5°, and 57°±0.5°.

In some embodiments, the compositions of the present disclosure may have an XRD pattern having one, two, three, or four peaks selected from the group consisting of 14.6°±0.5°, 29.3°±0.5°, 33.9°±0.5°, 49°±0.5°, and 57°±0.5°

The compositions may have a monoclinic C2/m (no. 12) space group as measured by XRD.

The present disclosure is also directed to a composite composition comprising an Argyrodite crystal phase and a Li₃P₂S₆X phase. The Li₃P₂S₆X phase may be the sulfide electrolyte material described above. In some embodiments, X is a halogen. The halogen includes fluorine, chlorine, bromine, iodine, or a combination thereof.

The composite composition may include an Argyrodite crystal phase. The composite composition may comprise at least about 90 wt % of an argyrodite crystal phase, such as at least about 91 wt % of an argyrodite crystal phase, at least about 92 wt % of an argyrodite crystal phase, at least about 93 wt % of an argyrodite crystal phase, at least about 94 wt % of an argyrodite crystal phase, at least about 95 wt % of an argyrodite crystal phase, at least about 96 wt % of an argyrodite crystal phase, at least about 97 wt % of an argyrodite crystal phase, at least about 98 wt % of an argyrodite crystal phase, or at least about 99 wt % of an argyrodite crystal phase.

The composite composition may include a Li₃P₂S₆X phase. The composite composition may include about 10 wt % or less of the Li₃P₂S₆X phase. For example, the composite composition may include about 10 wt % or less, about 9.9 wt % or less, about 9.8 wt % or less, about 9.7 wt % or less, about 9.6 wt % or less, about 9.5 wt % or less, about 9.4 wt % or less, about 9.3 wt % or less, about 9.2 wt % or less, about 9.1 wt % or less, about 9.0 wt % or less, about 8.9 wt % or less, about 8.8 wt % or less, about 8.7 wt % or less, about 8.6 wt % or less, about 8.5 wt % or less, about 8.4 wt % or less, about 8.3 wt % or less, about 8.2 wt % or less, about 8.1 wt % or less, about 8.0 wt % or less, about 7.9 wt % or less, about 7.8 wt % or less, about 7.7 wt % or less, about 7.6 wt % or less, about 7.5 wt % or less, about 7.4 wt % or less, about 7.3 wt % or less, about 7.2 wt % or less, about 7.1 wt % or less, about 7.0 wt % or less, about 6.9 wt % or less, about 6.8 wt % or less, about 6.7 wt % or less, about 6.6 wt % or less, about 6.5 wt % or less, about 6.4 wt % or less, about 6.3 wt % or less, about 6.2 wt % or less, about 6.1 wt % or less, about 6.0 wt % or less, about 5.9 wt % or less, about 5.8 wt % or less, about 5.7 wt % or less, about 5.6 wt % or less, about 5.5 wt % or less, about 5.4 wt % or less, about 5.3 wt % or less, about 5.2 wt % or less, about 5.1 wt % or less, about 5.0 wt % or less, about 4.9 wt % or less, about 4.8 wt % or less, about 4.7 wt % or less, about 4.6 wt % or less, about 4.5 wt % or less, about 4.4 wt % or less, about 4.3 wt % or less, about 4.2 wt % or less, about 4.1 wt % or less, about 4.0 wt % or less, about 3.9 wt % or less, about 3.8 wt % or less, about 3.7 wt % or less, about 3.6 wt % or less, about 3.5 wt % or less, about 3.4 wt % or less, about 3.3 wt % or less, about 3.2 wt % or less, about 3.1 wt % or less, about 2.0 wt % or less, about 2.9 wt % or less, about 2.8 wt % or less, about 2.7 wt % or less, about 2.6 wt % or less, about 2.5 wt % or less, about 2.4 wt % or less, about 2.3 wt % or less, about 2.2 wt % or less, about 2.1 wt % or less, about 2.0 wt % or less, about 1.9 wt % or less, about 1.8 wt % or less, about 1.7 wt % or less, about 1.6 wt % or less, about 1.5 wt % or less, about 1.4 wt % or less, about 1.3 wt % or less, about 1.2 wt % or less, about 1.1 wt % or less, about 1.0 wt % or less, about 0.9 wt % or less, about 0.8 wt % or less, about 0.7 wt %, about 0.6 wt % or less, about 0.5 wt % or less, about 0.4 wt % or less, about 0.3 wt % or less, about 0.2 wt % or less, about 0.1 wt % or less, or about 0.05 wt % or less.

The composite compositions of the present disclosure may have characteristic XRD pattern peak intensities. As used herein, the intensity of the peaks at 30.5°±0.50° is referred to as I_{A}, the intensity of the peaks at 29°±0.50° is referred to as I_{NEW-1}, the intensity of the peaks at 34°±0.50° is referred to as I_{NEW-2}, and the intensity of the peaks at 14.9°+0.50° is referred to as I_{NEW-3}. The relative peak intensities between two peaks refers to the ratio of the peak intensities. For example, the relative peak intensities between Iₓ and I_{NEW-1} refers to the ratio of the value of Iₓ to I_{NEW-1}.

The relative peak intensity ratio between Iₓ and I_{NEW-1} may be from about 100:1 to about 10:1; for example, the relative peak intensity ratio between Iₓ and I_{NEW-1} may be about 100:1, 95:1, 90:1, 85:1, 80:1, 75:1, 70:1, 65:1, 60:1, 55:1, 50:1, 45:1, 40:1, 35:1, 30:1, 25:1, 20:1, 15:1, or about 10:1. The relative peak intensity between Iₓ and I_{NEW-1} may be from about 100:1 to about 10:1, about 90:1 to about 20:1, about 80:1 to about 30:1, about 70:1 to about 40:1, or about 50:1 to about 45:1.

The relative peak intensity ratio between Iₓ and I_{NEW-2} may be from about 100:1 to about 10:1; for example, the relative peak intensity ratio between Iₓ and I_{NEW-2} may be about 100:1, 95:1, 90:1, 85:1, 80:1, 75:1, 70:1, 65:1, 60:1, 55:1, 50:1, 45:1, 40:1, 35:1, 30:1, 25:1, 20:1, 15:1, or about 10:1. The relative peak intensity between Iₓ and I_{NEW-2} may be from about 100:1 to about 10:1, about 90:1 to about 20:1, about 80:1 to about 30:1, about 70:1 to about 40:1, or about 50:1 to about 45:1.

The relative peak intensity ratio between Iₓ and I_{NEW-3} may be from about 100:1 to about 10:1; for example, the relative peak intensity ratio between Iₓ and I_{NEW-3} may be about 100:1, 95:1, 90:1, 85:1, 80:1, 75:1, 70:1, 65:1, 60:1, 55:1, 50:1, 45:1, 40:1, 35:1, 30:1, 25:1, 20:1, 15:1, or about 10:1. The relative peak intensity between Iₓ and I_{NEW-3} may be from about 100:1 to about 10:1, about 90:1 to about 20:1, about 80:1 to about 30:1, about 70:1 to about 40:1, or about 50:1 to about 45:1.

The present disclosure is also directed to a method of making Li₃P₂S₆X. The method comprises mixing the following precursors Li₂S, P₂S₅, and LiX at a specified ratio, wherein X is a halogen. In some embodiments, X may be chlorine.

The ratio of Li₂S: P₂S₅: LiCl may vary from 0.5:1:0.5 to 5:1:3. The amount of Li₂S may range from about 0.1 to about 5. For example, the amount of Li₂S may be about 0.5, about 0.75, about 1, about 1.25, about 1.5, about 1.75, about 2.0, about 2.25, about 2.5, about 2.75, about 3.0, about 3.25, about 3.5, about 3.75, about 4.0, about 4.25, about 4.5, about 4.75, or about 5.0. The amount of LiCl may range from about 0.1 to about 2. For example, the amount of LiCl may be about 0.5, about 0.75, about 1, about 1.25, about 1.5, about 1.75, or about 2.0.

The incorporation of LiCl may increase with increasing reaction temperature. Furthermore, minimization of Li₄P₂S₆ side phase may be observed.

### Electrochemical Cell Containing the Solid Composition of the Present Disclosure

Further provided herein is a solid-state electrochemical cell comprising an anode layer, a cathode layer, and a solid-state electrolyte layer, which may be referred to as a separator layer. The solid-state electrolyte layer is disposed between the anode layer and the cathode layer. In some embodiments, the solid-state electrochemical cell further comprises a first current collector layer and a second current collector layer, wherein the first current collector layer is disposed adjacent to the anode layer and the second current collector layer is disposed adjacent to the cathode layer. In some embodiments, the solid-state electrochemical cell further comprises a first current collector layer and a second current collector layer, wherein the first current collector layer is disposed adjacent to the cathode layer and the second current collector layer is disposed adjacent to the anode layer. A complete solid-state battery will typically encase the cell stack (electrodes, separators, and current collectors) in a pouch and include a first tab (outside the pouch) electrically coupled to the current collectors for the anodes, and a second tab (also outside the pouch) electrically coupled to the current collectors for the cathodes.

Preferably, the anode layer of the electrochemical cell comprises one or more anode active materials containing lithium metal, lithium alloys, silicon, silicon alloys, graphite, carbon, tin, or a combination thereof.

The anode layer may comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, or carbon nanotubes. In some aspects, the conductive additive may be present in the anode layer in an amount from about 0 wt % to about 10 wt %.

The anode layer may include the solid-state electrolyte of the present disclosure. In some embodiments, the solid-state electrolyte may be Li₃P₂S₆X (where “X” represents a halogen). The anode layer may further comprise an oxide, oxysulfide, sulfide, halide, nitride, or any other solid-state electrolyte known in the art. In some embodiments, the solid-state electrolyte further comprises one or more material combinations such as Li₂S—P₂S₅, Li₂S—P₂S₅-LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In another embodiment, the solid-state electrolyte may be selected from the group consisting of one or more of a Li₃PS₄, Li₄P₂S₆, Li₇P₃S₁₁, Li₁₀GeP₂S₁₂, and Li₁₀SnP₂S₁₂. In a further embodiment, the solid-state electrolyte may be selected from the group consisting of one or more of a Li₆PS₅Cl, Li₆PS₅Br, and Li₆PS₅I or may expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, or SCN. In yet another embodiment, the solid-state electrolyte may be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In some aspects, the solid state electrolyte may be present in the anode layer in an amount from about 0 wt % to about 20 wt %.

The anode layer may comprise a binder. In some embodiments, the binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR), and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the anode layer in an amount from about 0 wt % to about 5 wt %.

The cathode layer may comprise a cathode active material such as an NMC type cathode active material comprising at least nickel, manganese, and cobalt which can be expressed as, e.g., Li(NiₐCo_{b}Mn_{c})O₂ (0<a<1, 0<b<1, 0<c<1, a+b+c=1), NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or a combination thereof. In some aspects, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCO_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, or Li(NiₐCo_{b}Al_{c})O₂ (0<a<1, 0<b<1, 0<c<1, a+b+c=1). In other embodiments, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), or nickel sulfide (Ni₃S₂). In another embodiment, the cathode active material may comprise one or more of a metal fluoride, such as but not limited to iron fluoride (FeF₂, FeF₃), copper fluoride (CuF₂), zinc fluoride (ZnF₂), titanium fluoride (TiF₄), or nickel fluoride (NiF₂).

The cathode layer may comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, or carbon nanotubes. In some aspects, the conductive additive may be present in the cathode layer in an amount from about 1 wt % to about 10 wt %.

The cathode layer may include the solid-state electrolyte of the present disclosure. In some embodiments, the solid-state electrolyte may be Li3P2S6X (where “X” represents a halogen). The cathode layer may further comprise an oxide, oxysulfide, sulfide, halide, nitride, or any other solid-state electrolyte known in the art. In some embodiments, the solid-state electrolyte further comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃-LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In another embodiment, the solid-state electrolyte may be selected from the group consisting of one or more of a Li₃PS₄, Li₄P₂S₆, Li₇P₃S₁₁, Li₁₀GeP₂S₁₂, and Li₁₀SnP₂S₁₂. In a further embodiment, the solid-state electrolyte may be selected from the group consisting of one or more of a Li₆PS₅Cl, Li₆PS₅Br, and Li₆PS₅I or may expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, or SCN. In yet another embodiment, the solid-state electrolyte may be expressed by the formula Li_{8-y-z}P₂S_{9-y-z}X_{y}W_{z} (where “X” and “W” represents at least one halogen elements and or pseudo-halogen and where 0≤y≤1 and 0≤ z≤1) and where a halogen may be one or more of F, Cl, Br, I, and a pseudo-halogen may be one or N, NH, NH₂, NO, NO₂, BF₄, BH₄, AlH₄, CN, and SCN. In some aspects, the solid state electrolyte may be present in the cathode layer in an amount from about 5 wt % to about 20 wt %.

The cathode layer may comprise a binder. In some embodiments, the binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR), and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the cathode layer in an amount from about 0 wt % to about 5 wt %.

The electrolyte layer (also referred to herein as the “separator layer”) may comprise the solid-state electrolyte of the present disclosure. In some embodiment, the solid-state electrolytes may comprise an oxide, oxysulfide, sulfide, halide, nitride, or any other solid-state electrolyte known in the art. In further embodiments, the solid-state electrolytes may comprise a sulfide solid-state electrolyte. In some aspects, the sulfide solid-state electrolyte may be an argyrodite material. In some aspects, the one or more sulfide solid-state electrolytes may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂-LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂, or combinations thereof. In another embodiment, one or more of the solid electrolyte materials may be Li₆PS₅Cl, Li₆PS₅Br, Li₆PS₅I or may be expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, or combinations thereof, and the pseudo-halogen may be one or more of N, NH, NH₂, NO, NO₂, BF₄, BH₄, AlH₄, CN, SCN, or combinations thereof. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, or I, and the pseudo-halogen may be one or more of N, NH, NH₂, NO, NO₂, BF₄, BH₄, AlH₄, CN, SCN, or combinations thereof.

The electrolyte layer may further comprise a binder. In some embodiments, the binder may include a fluororesin containing vinylidene fluoride (VdF), hexafluoropropylene (HFP), tetrafluoroethylene (TFE), or derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the electrolyte layer in an amount from about 0% to about 20% by weight.

In some embodiments, the electrolyte layer may have a thickness from about 10 μm to about 40 μm. In some aspects, the electrolyte layer may have a thickness from about 10 μm to about 20 μm, about 10 μm to about 30 μm, about 20 μm to about 30 μm, about 20 μm to about 40 μm, or about 30 μm to about 40 μm. In some additional aspects, the electrolyte layer may have a thickness of about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, or about 40 μm.

The first current collector and the second current collector may comprise one or more of copper, aluminum, nickel, titanium, stainless steel, magnesium, iron, zinc, indium, germanium, silver, platinum, or gold. The current collector may further comprise a carbon coating on a side of the current collector adjacent to the composite anode or the cathode layer. In some embodiments, the first current collector or the second current collector may have a thickness from about 5 μm to about 10 μm. In preferred embodiments, the first current collector comprises copper, nickel, and/or steel.

The disclosure will now be illustrated with working examples, and which are intended to illustrate the disclosure and not intended to restrict any limitations on the scope of the present disclosure. Unless defined otherwise, all technical and scientific terms used herein have the same meaning as commonly understood to one of ordinary skill in the art to which this disclosure belongs.

### EXAMPLES

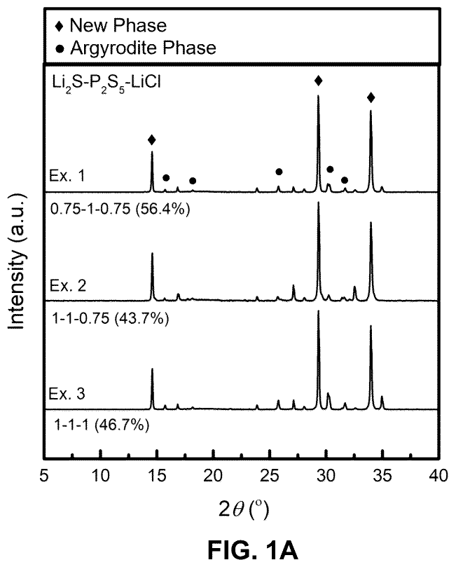

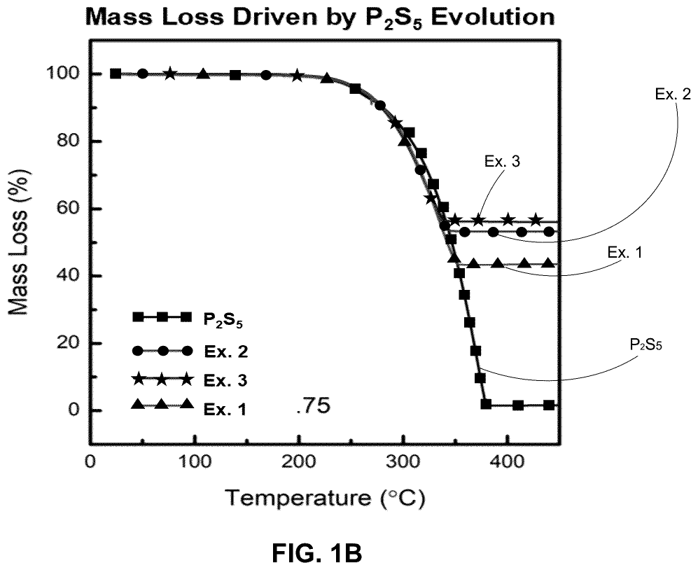

Example 1: Li₂S, P₂S₅, and LiCl were mixed at a ratio of 0.75:1:0.75. This resulted in an electrolyte material with a stoichiometry of Li_{2.25}P₂S_{5.75}Cl_{0.75}, Li_{5.5}P₄S_{11.5}Cl_{1.5}, Li₁₁P₈S₂₃Cl₃, or a combination thereof. FIG. 1 (top) shows an XRD pattern obtained.

Example 2: Li₂S, P₂S₅, and LiCl were mixed at a ratio of 1:1:0.75. This resulted in an electrolyte material with a stoichiometry of Li_{2.75}P₂S₆Cl_{0.75}. FIG. 1A (middle) shows an XRD pattern obtained.

Example 3: Li₂S, P₂S₅, and LiCl were mixed at a ratio of 1:1:1. This resulted in an electrolyte material with a stoichiometry of Li₃P₂S₆Cl. FIG. 1A (bottom) shows an XRD pattern obtained.

FIG. 1B shows a TGA graph describing the mass loss of P₂S₅ in Examples 1-3.

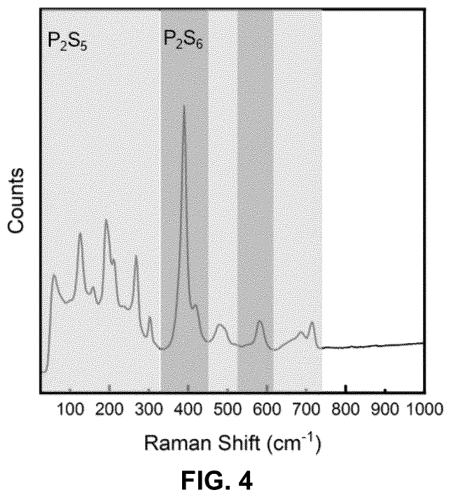

The electrolyte was characterized by Raman, FTIR and XRD to determine the composition. FIG. 4 is a Raman spectra that demonstrates that the electrolyte has P₂S₆ species and residual P₂S₅. XRD spectra further suggests the presence of residual P₂S₅ in the electrolyte. Due to the presence of the P₂S₆ and successful synthesis with equivalent ratios of Li₂S, P₂S₅ and LiCl, Li₃P₂S₆Cl is a probable molecular formula.

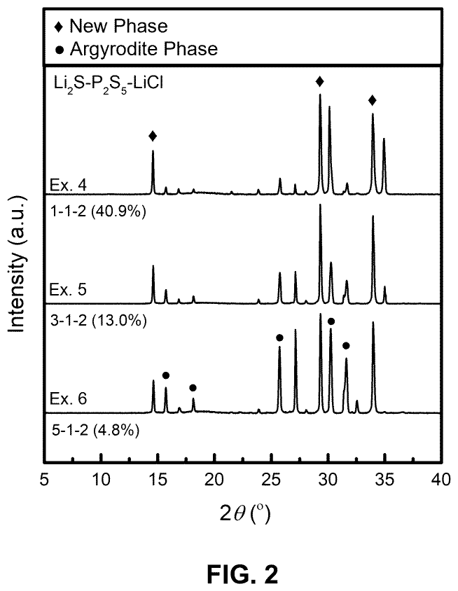

Example 4: Li₂S, P₂S₅, and LiCl were mixed at a ratio of 1:1:2. This resulted in an electrolyte material with a stoichiometry of Li₄P₂S₆Cl₂, Li₂PS₃Cl, or a combination thereof. FIG. 2 (top) shows an XRD pattern obtained.

Example 5: Li₂S, P₂S₅, and LiCl were mixed at a ratio of 3:1:2. This resulted in an electrolyte material with a stoichiometry of Li₄PS₄Cl. FIG. 2 (middle) shows an XRD pattern obtained.

Example 6: Li₂S, P₂S₅, and LiCl were mixed at a ratio of 5:1:2. This resulted in an electrolyte material with a stoichiometry of Li₆P₂S₅Cl. FIG. 2 (bottom) shows an XRD pattern obtained.

FIG. l shows that the LiCl incorporation increases with increasing reaction temperature and minimization of Li₄P₂S₆ side phase.

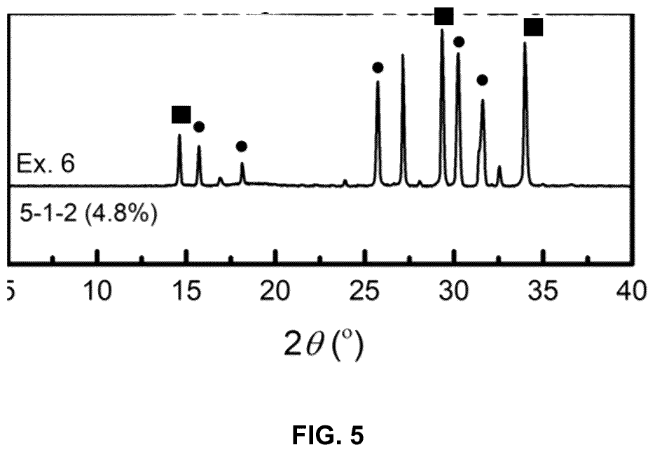

Example 7: A composite composition with an Argyrodite phase and the electrolyte of Example 6 (Li₃P₂S₆Cl phase) was prepared. The composite had 5 wt % or less of the electrolyte. FIG. 5 shows an XRD pattern of the composite. The black dots represent the peak positions of the Argyrodite material and the black triangles the 3 major peak positions of the electrolyte of Example 6.

As seen in FIG. 5, the most intense peak of the Argyrodite phase is 2θ=30.5°±0.5°. The most intense peak of the electrolyte of Example 6 include 2θ=14.9°±0.5°, 29°±0.5°, and 34°±0.5°.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A composition comprising Li3P2S6X, wherein X is a halogen.

2. The composition of claim 1, wherein X is chlorine, bromine, or a combination thereof.

3. The composition of claim 1, wherein the composition comprises an XRD peak at 2θ=29.3°±0.5°.

4. The composition of claim 1, wherein the composition comprises an XRD peak at 2θ=33.9°±0.5°.

5. The composition of claim 1, wherein the composition comprises an XRD peak at 2θ=14.6°±0.5°.

6. The composition of claim 1, wherein the composition comprises an XRD peak at 2θ=49°±0.5°.

7. The composition of claim 1, wherein the composition comprises an XRD peak at 2θ=57°±0.5°.

8. The composition of claim 1, wherein the composition comprises an XRD peak at 2θ at three or more of 14.6°±0.5°, 29.3°±0.5°, 33.9°±0.5°, 49°±0.5°, and 57°±0.5°.

9. The composition of claim 1, wherein the composition comprises an XRD peak 2θ at four or more of 14.6°±0.5°, 29.3°±0.5°, 33.9°±0.5°, 49°±0.5°, and 57°±0.5°.

10. The composition of claim 1, wherein the composition comprises an XRD peak at 2θ=14.6°±0.5°, 29.3°±0.5°, 33.9°±0.5°, 49°±0.5°, and 57°±0.5°.

11. The composition of claim 1, wherein the composition comprises an XRD peak at 2θ=14.6°±0.3°, 29.3°±0.3°, 33.9°±0.3°, 49°±0.3°, and 57°±0.3°.

12. The composition of claim 1, wherein the composition comprises an XRD peak at 2θ=14.6°±0.1°, 29.3°±0.1°, 33.9°±0.1°, 49°±0.1°, and 57°±0.1°.

13. A composite composition comprising an Argyrodite phase and a Li₃P₂S₆X phase, wherein X is a halogen.

14. The composite composition of claim 13, wherein X is chlorine, bromine, or a combination thereof.

15. The composite composition of claim 13, wherein the composite comprises an XRD peak at 2θ=29°±0.5°.

16. The composite composition of claim 13, wherein the composite comprises an XRD peak at 2θ=34°±0.5°.

17. The composite composition of claim 13, wherein the composite comprises an XRD peak at 2θ=14.9°±0.5°.

18. The composite composition of claim 13, wherein the composite comprises an XRD peak at 2θ=30.5°±0.5°.

19. The composite composition of claim 13, wherein the composition comprises an XRD peak at 2θ at three or more of 14.9°±0.5°, 29°±0.5°, 30.5°±0.5°, and 34°±0.5°.

20. The composite composition of claim 13, wherein the composition comprises an XRD peak at 2θ=14.9°±0.5°, 29°±0.5°, 30.5°±0.5°, and 34°±0.5°.

21. The composite composition of claim 13, wherein the composition comprises an XRD peak at 2θ=14.9°±0.3°, 29°±0.3°, 30.5°±0.3°, and 34°±0.3°.

22. The composite composition of claim 13, wherein the composition comprises an XRD peak at 2θ=14.9°±0.1°, 29°±0.1°, 30.5°±0.1°, and 34°±0.1°.

23. The composite composition of claim 13, wherein the composite composition comprises about 10 wt % or less of the Li₃P₂S₆X phase.

24. The composite composition of claim 13, wherein the composite composition comprises about 5 wt % or less of the Li₃P₂S₆X phase.

25. The composite composition of claim 13, wherein the composite composition comprises about 3 wt % or less of the Li₃P₂S₆X phase.

26. The composite composition of claim 13, wherein the composite composition comprises about 1 wt % or less of the Li₃P₂S₆X phase.

27. The composite composition of claim 20, wherein the ratio of peak area of peak at 30.5° to ratio of peak area of peak at 29° is from about 100:1 to about 10:1.

28. The composite composition of claim 20, wherein the ratio of peak area of peak at 30.5° to ratio of peak area of peak at 34° is from about 100:1 to about 10:1.

29. The composite composition of claim 20, wherein the ratio of peak area of peak at 14.9° to ratio of peak area of peak at 34° is from about 100:1 to about 10:1.

30. A composition comprising Li_{3±0.75}P_{2±0.75}S_{6±0.75}X_{1±0.75}, wherein X is a halogen, and wherein the composition comprises an XRD peak at 2θ at three or more of 14.6°±0.5°, 29.3°±0.5°, 33.9°±0.5°, 49°±0.5°, and 57°±0.5°.

31. A method of making Li₃P₂S₆X, the method comprising mixing Li₂S, P₂S₅, and LiX, wherein X is a halogen.
